(19) United States
(12) Patent Application Publication
(10) Pub. No.: US 2008/0185359 A1
(43) Pub. Date: Aug. 7, 2008

(54) Foldable CPAP breathing hose support boom

(76) Inventor: Edward S. Baxter, Georgetown, TX (US)

Correspondence Address: Edward S. Baxter, 1280 CR 100, Georgetown, TX, 78626-2255, US

(21) Appl. No.: 11/836,081

(22) Filed: Aug. 8, 2007

Related U.S. Application Data
(60) Provisional application No. 60/838,267, filed on Aug. 18, 2006.

(51) Int. Cl. B66C 23/00

(52) U.S. Cl. 212/347

(57) ABSTRACT

A device for positioning and supporting the cumbersome weight of an air or gas breathing plenum (hose), over a person's head during rest or sleep, to thereby increase free movement and reduce distress to the user. The device consisting essentially of a collapsible sectional tubular boom, supported by a planar wire form base captured by the weight of the user's mattress, and an elastic cord passing through the hollow interior of the tubing sections used to: capture the hose at the outboard end of the boom, keep the boom erect, affix the boom to the supporting base, and said elastic cord also to gather and order the collapsed boom sections during folded storage. Said device is particularly convenient for use with CPAP equipment used in the control of sleep apnea, as it is sized to fit within the travel bag of even the smallest of CPAP machines during travel away from home.

### CROSS REFERENCED TO RELATED APPLICATIONS

This non-provisional patent application is related to Provisional Application No. 60/838,267 filed Aug. 18, 2006 by applicant and claims priority from that application.

### FEDERALLY SPONSORED RESEARCH/DEVELOPMENT

Not Applicable

### SEQUENCE LISTING

Not Applicable

### BACKGROUND OF THE INVENTION

1. Field of the Invention

The present invention relates to the field of devices and methods for holding breathing devices and the like in place on a person's head.

2. Description of the Background Art

Breathing devices, such as masks and the like, typically convey air or gases through a flexible small diameter plenum (hose) from the supply equipment and into a person's nose or mouth through said masks or the like, this is particularly applicable to CPAP continuous positive airway pressure equipment used in the control of sleep apnea.

U.S. Pat. No. 6,347,631 to Hansen describes a device for positioning a breathing apparatus over a breathing orifice in the head of a person. The device includes a forward anchor and a spring connector.

U.S. Pat. No. 6,347,631 to Kwok et al describes an adjustable forehead support for a nasal mask. The forehead support utilizes a dual-arm system which adjusts the position of the forehead support vis-a-vis the mask and/or air flow tube. The angle of the mask to the face may be adjusted.

U.S. Pat. No. 5,216,770 to Holt describes a body support device having a resilient surface with channels disposed in the surface for retaining tubing therein.

U.S. Pat. No. 7,040,581 to Noelke et al describes a comfort enhancer for supporting a CPAP mask and hose is designed to be portable and deployed on any standard bed. The support has a bi-pod base placed between the mattress and the inner spring of the bed. An upright pole, removably attached to the base and adjustable in height, carries hose clamps. A bracket attached to the top of the pole has a cantilever arm pivotally attached by a spring loaded pulley. The cantilever arm also carries hose clamps. The comfort enhancer supports the air hose at a distance from the bed and above the head of the user allowing the hose descend vertically to the user. The cantilever arm pivots to compensate for the movement of the mask and the spring loaded pulley absorbs the shock to the line.

There are several hose support devices offered for sale online. “The Hose Buddy” is an adjustable height support with a swing arm and hook and loop hose supports. The “Airway Support Arm” includes aluminum tube sections and a headboard clamp. The “Hose Support” is made of ½″ diameter CPVC tubing and fittings which may be taken apart.

Known devices have several drawbacks, and there is a need for a simpler and less intrusive device to retain a CPAP hose. The hose for conveying the air or gas is long, cumbersome, and relatively heavy, as the hose's weight and cumbersomeness is not supported over the users head and thus causes restriction to free movement of the user's head during sleep or resting, thus distress. This can contribute to lack of compliance with use of the equipment.

A support, if rigged by the user, is typically the hose draped over the head board of the bed, or similar, and as such is not specifically designed to capture, position and support the weight of the hose over the users head to allow maximum free movement. Or, a head board or other rigged support is not to be found at all, as when for example the user is away from home on a trip.

There remains a need in the art for improved methods and devices for positioning and supporting the weight and length of the air or gas conveying hose over a person's head during rest and sleep to increase and maximize free movement.

### SUMMARY OF THE INVENTION

In accordance with the present invention, a device is provided for positioning and supporting a plenum (hose) conveying air or gases from the supply equipment and into a person's nose or mouth through a mask or the like. The present invention is particularly applicable to CPAP equipment used in the control of sleep apnea.

The device comprises a sectional tubular boom with a tensioning means, which is supported and held erect by a planar base, said base designed to slip under the mattress of a bed, held there by the weight of the mattress. A loop projects from the overhead end of the boom, through which the air or gas hose is placed, and thereby positioned and supported over the user's head. An elastic cord, passing through the tubular boom sections, forms the hose loop, binds the boom pieces rigid when erected, or keeps them gathered and ordered when collapsed, and holds the erected boom onto the base during use, utilizing a hook that engages the base. A section of curly cord may be inserted onto the loop, to act as a roller for hose movement back and forth, within the loop, with the user's movement. Also, a ground spike for outdoor use, or fastener mounted support hardware for a more permanent installation, could be substituted for the planar base, as desired.

One aspect of the current invention is that its ease of use, small size, and light weight make it very useful for travel.

### BRIEF DESCRIPTION OF THE SEVERAL VIEWS OF THE DRAWINGS

FIG. 1 is a side view of one embodiment of an assembled hose boom held in position by a mattress.

FIG. 2A is an enlarged exploded cross section view of a tubular section plain end and a tubular section narrow diameter end.

FIG. 2B is an enlarged exploded cross section view of an alternative tube section coupling with a molded larger end and a plain end.

FIG. 2C is an enlarged exploded cross section view of an alternative tube section external coupling.

FIG. 3 is a detailed side view of an alternative loop hose support.

FIG. 4 is a detailed perspective view of a planar base.

FIG. 5 is a side view of a ground spike base.

FIG. 6 is a perspective view of a bracket base.

FIG. 7 is a perspective view of a travel bag to hold the boom components.

FIG. 8A is a side view of a hook.

FIG. 8B is a bottom view of the hook of FIG. 8A.

FIG. 8C is a bottom perspective view of the hook of FIG. 8A engaging the end of an elastic cord.

FIG. 9 is a side view of the elastic cord assembly.

### DETAILED DESCRIPTION OF THE INVENTION

### Foldable Boom with Planar Base

The present invention provides a novel device and method for positioning an air or gas plenum (hose) over a person's head during the use of a breathing mask, or similar device.

The present invention is particularly applicable to CPAP equipment used in the control of sleep apnea.

In preferred embodiments, the invention is for positioning and supporting an air or gas hose such as used in a breathing mask or respirator mask. However, the invention can also be applied for positioning and supporting any flexible conduit(s) over a person's head or body, such as intravenous tubing, or low voltage monitoring wiring.

### Foldable Boom

FIG. 1 is a side view of one embodiment of an assembled hose boom 300 held in position by a mattress. In this embodiment, there are 5 tubular sections including a first vertical base tubular section 310, a second vertical base tubular section 320, a third vertical base tubular section 330, a fourth transition tubular section 340, and a fifth uppermost support tubular section 350. The term “tubular” refers to any hollow cross section, and is not limited to circular tubes. For instance, the cross section may be square, elliptical, asymmetrical, or other complete or partially open circumferential shape. In this embodiment, the fourth transition tubular section 340 is bent at a 45 degree angle 346 about 2″ (5.08 cm) from the tube section end 342, thereby creating the horizontal run of the boom assembly necessary to position the outboard supporting end of the boom and hose by the elastic cord loop 450. This section may be reversed to accommodate particular rise and run needs.

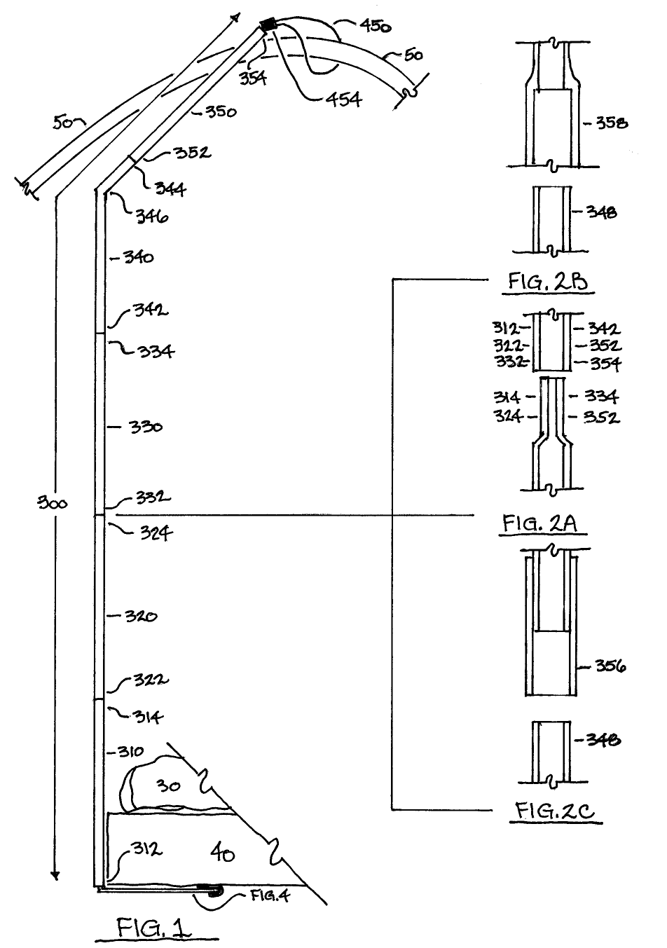

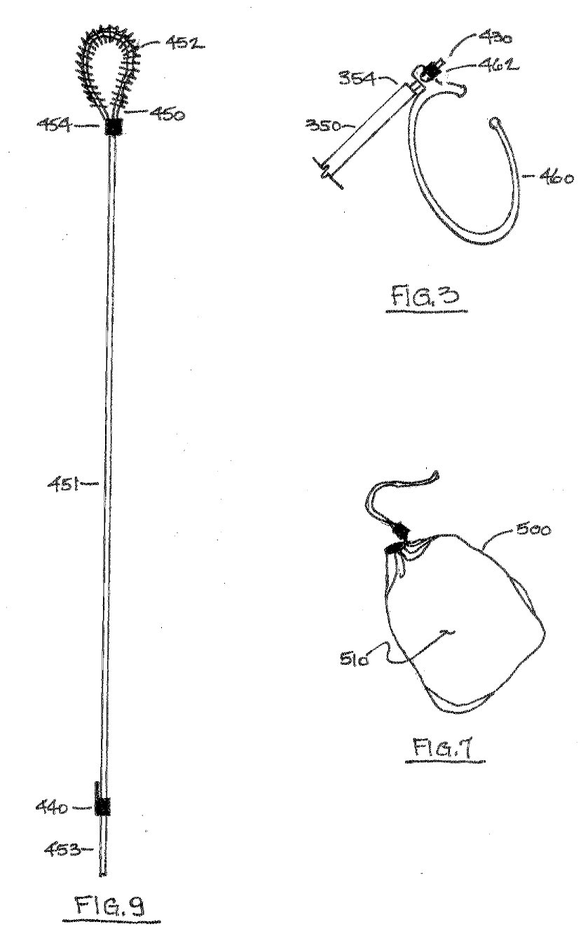

In this example, the tubular sections are assembled by inserting a plain end of one section over a narrowed diameter end of another section. In one example, the narrowed diameter end has a length of about 0.75 to 1.00 inches (1.905 to 2.54 cm) and an outer diameter slightly smaller than the inner diameter of the other section. FIG. 2A is an enlarged exploded cross section view showing this type of connection. Advantages to this approach include a streamlined assembled boom, and good strength of connection. In this embodiment, tube section ends 312, 322, 332, 342, 344, and 354 are plain end, whereas, tube ends 314, 324, 334, and 352 are formed to a smaller narrow diameter to socket into the adjacent plain tube ends.

In this example, the boom section lengths all at 8″ (20.32 cm) and the base width and length of 5″ (12.7 cm)×8″ (20.32 cm) dimensions were all designed to match the smallest of CPAP machines presently made. In addition, to achieve the greatest simplicity of manufacture, all boom sections were made identical in length, and 4 of the 5 sections, all but the bent transition section, were designed to be identical in end treatment manufacture, for same said reason. Further still, the one atypical bent transition section, since it requires no end treatment, can be sent immediately to the bending process, once it is cut to the same identical length as the other sections.

FIG. 2B is an enlarged exploded cross section view of an alternative tube section coupling with a molded larger end and a plain end. FIG. 2C is an enlarged exploded cross section view of an alternative tube section external coupling. For instance, an external sleeve coupling may be applied to the tube end 356, or a coupling that may be molded into the tube end 358. Either of these couplings would receive the adjacent plain tube end 348. These examples may use alternative tubing materials, such as plastic or other material, whereby an external sleeve coupling is applied to the tube end, or a female coupling is molded into the tube end.

These five sections are one example embodiment, and additional or fewer tube sections may be added or deleted at the vertical or horizontal run portions of the boom 300 to accommodate particular rise and run needs.

In this example, the tubular sections may be T6 6061 aluminum, 0.375″ (0.9525 cm) O. D.×0.035″ (0.0889 cm) wall×0.305″ (0.7747 cm) I.D., 8″ (20.32 cm) length, and anodized, stacked one upon the other and held erect by the combination of the narrowed diameter end of one tube section fitting snugly into the adjacent tube section plain end and held in that mated position by an elastic cord passing through the hollow interior of the tubing sections, which has been placed in tension. Thus the boom sections are in compression as they are captured between the base stob and the loop clamp or hardware loop. In this example, the device weighs about ¼ pound (114 grams).

### Support Base

FIG. 4 is a detailed perspective view of a planar base. In this example, the boom 300 is attached to a supporting base 200 by inserting the lower plain end 312 of first vertical base tubular section 310 over a stob 290 on the base. The boom is held in place on the base by the tensioned elastic cord 430 stretched past the base turning point 297 to the base attachment point 295, utilizing a hook 420 for said purpose, to keep the boom erect, as the base area 202 is held fast under the weight of the bed mattress 40. Both the mattress and pillow 30 shown are not to similar proportionate scale to the boom shown.

In this example, the base is formed of a ⅛″ (0.125 cm) diameter painted bent wire form, 5″ (12.7 cm)×8″ (20.32 cm), or any similar area formed of other material. On one side of the base, the free ends of the wire are turned up and together at a 90 degree angle to the plane of the base, about 1″ (2.54 cm), to create a base projection stob 290 that is designed to fit snugly into the lower end 312 of a boom section to hold the boom erect.

The elastic cord 430 passing out from the bottom of the boom, is placed in further tension, and thus the boom sections are held in compression, as the cord is drawn past a turning point 297 and hooked onto the opposite side of the base 295, through the use of a hook 420, affixed to the elastic cord by tying, or some other means.

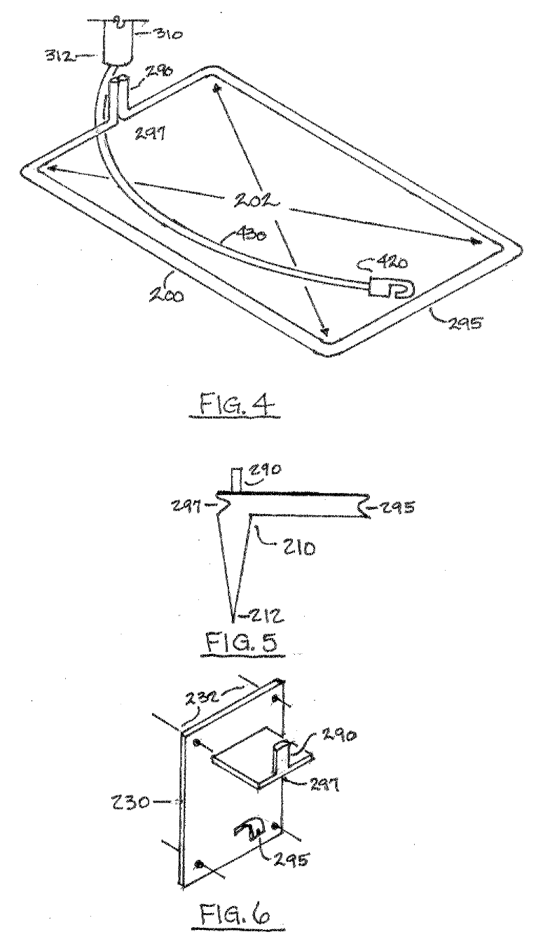

Two additional alternative boom support bases are shown. FIG. 5 is a side view of a ground spike base 210 for outdoor use such as camping. FIG. 6 is a perspective view of a fixed hardware base 230, utilizing fasteners or removable adhesive strips 232, such as for mounting to a bed frame. For outdoor use, the ground spike may penetrate into the earth to resist the tipping forces upon the outboard end of the boom imposed by the weight of the hose being supported during use. The fixed hardware base utilizes fasteners or removable adhesive strips, so as not to damage furniture, to resist tipping forces. In these examples, the supporting bases utilize a boom socketing member, or stob 290, a means of further tensioning the elastic cord by stretching some distance to an attachment point 295, past a turning point 297 and means of resisting tipping forces 202, 212, or 232.

An elastic cord 430 passes through all tubular sections of the boom 300, and acts to gather or erect the boom sections. One end of the elastic cord has a hose loop 450 held against the outboard end of the boom. An air hose such as a CPAP hose may be passed through the loop. The loop supports the hose over the users head for air or gas delivery.

### Tensioning Cord Assembly

The elastic cord assembly FIG. 9 comprises a single piece of elastic cord, wherein a loop 450 is formed at one end using a clamp or crimped sleeve 454, a section of curly cord 452 may be inserted onto said loop to act as a roller for the air hose it captures and supports, another portion of the elastic cord from the loop clamp to the barb tip 451 and a final portion of the elastic cord from the barb tip 440 to the end of said elastic cord. In this example, the elastic cord loop 450 is used to hold the air hose at the outboard end of the boom 354 is formed by use of a clamp or crimped sleeve 454. A section of curly cord 452 is inserted onto the elastic cord loop to act as a roller for the air hose 50 movement back and forth within the loop, during the user's movement.

FIG. 3 is a detailed side view of an alternative loop hose support. In this example, a hardware loop 460 is attached to the end of the elastic cord by some means, in this embodiment a retainer 462.

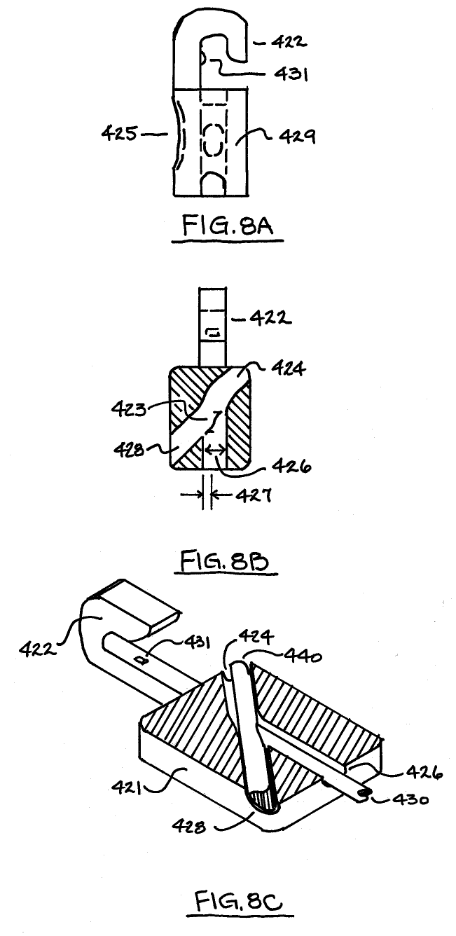

FIG. 4 shows a hook 420 provided at the other end of the elastic cord for assembling the boom to the base 200. FIGS. 8A-8C show details of an example hook. In this example, a quick connect hook includes the hook body 421, offset dimensions 423 and 427, diameters 424, 426, and 428, a thumb indent feature 425, and a retainer 431. In this example, the end of the elastic cord 430 has a barb tip 440 crimped upon it. In this example, the hook body has interior cavity diameters of 0.2406″ (0.6111 cm) at 424, 0.1875″ (0.4762 cm) at 426, and 0.1563″ (0.397 cm) at 428; offsets dimensions 0.025″ (0.0635 cm) at 423 and 0469″ (0.1191 cm) at 427. The barb tip 440 is a #304 C. Sjoberg.

In this example, the elastic cord assembly, FIG. 9, is made from a single piece of 3/32″ (0.2381 cm) diameter elastic cord, a portion of which, 36″ (91.44 cm) long 451, passes through the hollow interior of all boom sections. At the upper outboard end of the boom, the elastic cord assembly has a loop, 6″ (15.24 cm) long 450 formed by use of a cord clamp or crimped sleeve 454, said loop is used to hold and support the weight of the hose over the user's head. A section of “curly cord” 452, such as 0.115″ (0.2921 cm) O.D. 90A solid PUR coiled rod×5.3″ (13.462 cm) long, may be inserted onto the elastic cord loop 450 to act as a roller for the air/gas hose, as it moves back and forth within the loop, during the user's movement. The last portion of the elastic cord from the barb tip 440 to the end of the elastic cord assembly 453 is 6″ (15.24 cm) long and provides the length necessary to grasp the cord end protruding from the boom sections 300 and boom end 412. During assembly, the cord segment 451 is stretched, and thus tensioned, and the barb tip 440 is affixed within the quick connect hook, thus placing the boom sections in compression.

This section of the elastic cord 453 is cut off and discarded, once the quick connect hook is in place. Since the loop member and hook remain in place, after assembly, the elastic cord section 451 within the boom sections acts to gather and order the boom sections when their ends are unmated and the sections are folded for storage and travel, within their bag.

In addition to holding the boom sections in place, the elastic cord provides some give to the breathing hose.

The elastic cord assembly, FIG. 9, and in particular the barb tip, 440, is both small enough to pass through the hollow boom section interiors, but also strong enough to withstand normal user loadings, and thus enhances the efficiency and safety of manufacture by a separate company whose business is building such elastic cord assemblies.

### Travel Bag

FIG. 7 is a perspective view of a drawstring travel bag 500 to hold the collapsed and folded boom sections, the base, and an instructional card for boom use and repair 510.

It should be noted that this embodiment of the CPAP Hose Boom has been sized so that when it is collapsed, folded and stored in its travel bag, it will as such conveniently fit into the carry bag of even the smallest of CPAP equipment presently manufactured. In this example, the longest dimension of the base and the tubular sections are about 8 inches.

The bag may be made of fabric sewn into a pouch, with a simple drawstring closure, or any similar closure.

### Foldable Boom with Planar Base

In this embodiment, a boom is assembled and placed under the sides or head of a mattress. The boom may be used to support intravenous tubing or low voltage monitor wiring.

### Assembly and Disassembly

In this embodiment, a boom assembly is provided as described above. While the present example includes five boom tubular sections, this assembly method also applies to booms with more or fewer than five sections.

In a first step, the base and the folded boom are removed from a travel bag. The base is placed on a flat surface.

At this point, the boom has five sections which are folded approximately parallel. The elastic cord runs through each of the sections and is held in place by a hook on one end and by a clamp on the other end. Thus, the cord holds the sections in a relative orientation so that the sections can only be assembled in the correct sequence.

Holding the first vertical base tubular section 310 in one hand, and holding the second vertical base tubular section 320 in the other hand, the sections are attached by inserting the first end 322 of the second vertical base tubular section over the second end 314 of the first vertical base tubular section 310. In this example, end 322 was a plain end and end 314 was a narrow diameter. In other examples, those end shapes may be reversed, or a coupling or other segment assembly element may be provided.

The third vertical base tubular section 330 is attached by inserting its first end 332 over the second end 324 of the second vertical base tubular section.

The fourth transition tubular section 340 is attached by inserting its first end 342 over the second end 334 of the third vertical base tubular section.

The fifth uppermost support tubular section 350 is attached by inserting its first end 352 into the second end 344 of the fourth transition tubular section 340.

Holding the first vertical base tubular section 310 in one hand, the hook 420 is grasped with the other hand and pulled so that it is about 9-10 inches (22.86 to 25.4 cm) away from the bottom of the first vertical base tubular section.

The first end 312 of the first vertical base tubular section 310 is inserted over the stob 290 on the base 200, and the hook is attached to the far end 295 of the base.

The base may be placed under the side or head of a mattress.

A breathing hose is then inserted in the support loop 452 or 460.

To fold the device for storage or travel, the reverse procedure is used. The breathing hose is removed, and the base is removed from the mattress.

The hook is detached from the base, and each boom section is pulled away from its neighboring sections, and the sections are folded approximately parallel. The base and folded boom may be placed in the travel bag.

Variations in materials, dimensions, and designs will be apparent to those skilled in the art, and the current invention is not limited to the foregoing embodiments and examples.

What is claimed is:

1. A hose support device for positioning and supporting a breathing hose in proximity to a person's head during rest or sleep, the device comprising
a base;
a collapsible tubular boom comprising a plurality of tubular boom sections, each boom section comprising
a first end having a diameter of the section or a narrow diameter, and
a second end having a diameter of the section or a narrow diameter, such that the plurality of tubular boom sections may be assembled in series to form an erect boom; and
an elastic tensioning cord assembly comprising
an elastic cord run through all tubular boom sections, the cord having a first end attached to the base and a second end,
a cord retention element attached to the cord in proximity to the second end of the cord, such that the cord retention element is larger than the diameter of the tubular sections, and
a hose support element in proximity to the second end of the cord.

2. The hose support device of claim 1 wherein
at least one tubular boom section comprises a bend.

3. The hose support device of claim 1 wherein
the longest dimension of the base and any tubular section is less than about 8 inches.

4. The hose support device of claim 1 further comprising
a travel bag to hold collapsed boom sections and the base.

5. The hose support device of claim 1 wherein
the base is a wire form planar base that is inserted under a mattress.

6. The hose support device of claim 1 wherein
the base is a ground spike.

7. The hose support device of claim 1 wherein
the base is a bracket mounted to furniture.

8. The hose support device of claim 1 wherein
the first end of the cord is attached to the base with a hook.

9. The hose support device of claim 8 wherein
the cord is attached to the hook with a textile braid barb tip.

10. A hose support device for positioning and supporting a breathing hose in proximity to a person's head during rest or sleep, the device comprising
a base comprising
a base frame, and
a vertical stob;
a collapsible tubular boom comprising
a first vertical base tubular section comprising
a first end detachably connected to the base vertical stob, and
a second narrowed diameter end,
a second vertical tubular section comprising
a first end detachably connected to the second end of the first vertical base tubular section, and
a second narrowed diameter end,
a third vertical tubular section comprising
a first end detachably connected to the second end of the second vertical base tubular section, and
a second narrowed diameter end,
a fourth transition tubular section comprising
a first end detachably connected to the second end of the third vertical base tubular section,
a second end, and
at least one bend located between the end and the second end, and
a fifth hose support tubular section comprising
a first narrowed diameter end
a second end
a elastic tensioning cord assembly comprising
an elastic cord run through all boom tubular sections, the cord having a first end and a second end,
a hook attached to the first end of the cord, such that the hook is detachably connected to the base,
a cord clamp attached to the cord in proximity to the second end of the cord, such that the cord clamp is larger than the diameter of the second end fifth hose support tubular section, and such that a hose support loop is formed at the second end, and
a curly cord hose support roller placed onto the hose support loop.

11. The hose support device of claim 10 wherein
the longest dimension of the base and any tubular section is less than about 8 inches.

12. The hose support device of claim 10 further comprising
a travel bag to hold collapsed boom sections and the base.

13. The hose support device of claim 10 wherein
the base is inserted under a mattress.

14. The hose support device of claim 10 wherein
the cord is attached to the hook with a textile braid barb tip.

15. A method of assembling a hose support boom, the method comprising
providing a boom assembly comprising
a base,
a collapsed tubular boom comprising a plurality of tubular boom sections, each boom section comprising
a first end having a diameter of the section or a narrow diameter, and
a second end having a diameter of the section or a narrow diameter, such that the plurality of tubular boom sections may be assembled in series to form an erect boom, and
an elastic tensioning cord assembly comprising
an elastic cord run through all tubular boom sections, the cord having a first end attached to the base and a second end,
a cord retention element attached to the cord in proximity to the second end of the cord, such that the cord retention element is larger than the diameter of the tubular sections, and
a hose support element in proximity to the second end of the cord,
attaching the first end of a second tubular boom section to the second end of the first tubular boom section;
continuing to attach a tubular boom section to the second end of the previous boom section until all boom sections are attached; and
attaching the first end of a first tubular boom section to a portion of the base.

16. The method of claim 15 further comprising
placing a breathing hose in the hose support element.

17. The method of claim 15 further comprising
placing intravenous tubing in the hose support element.

18. The method of claim 15 further comprising
placing low voltage monitor wiring in the hose support element.

19. The method of claim 15 further comprising
placing the planar base under a mattress.

20. The method of claim 15 further comprising
disassembling the boom by
removing the first tubular boom section from the base, and
for each tubular boom section, disassembling the tube section from all adjacent tubular boom sections;
folding the boom such that all tubular boom sections are approximately parallel; and
placing the base and the folded boom sections in a bag.
